(19) United States
(12) Patent Application Publication
(10) Pub. No.: US 2026/0070444 A1
(43) Pub. Date: Mar. 12, 2026

(54) ELECTRIC VEHICLE COMMUNICATIONS

(71) Applicant: Daimler Truck North America, LLC, Portland, OR (US)

(72) Inventors: William BILLINI, Portland, OR (US); Yun Ma, Portland, OR (US)

(21) Appl. No.: 19/319,148

(22) Filed: Sep. 4, 2025

Related U.S. Application Data
(60) Provisional application No. 63/692,000, filed on Sep. 6, 2024.

(51) Int. Cl. B60L 53/30; H04W 4/44; H04W 4/80

(52) U.S. Cl. CPC B60L 53/305; H04W 4/44; H04W 4/80

(57) ABSTRACT

The present disclosure provides systems and methods for capturing communications between an electric vehicle and electric vehicle supply equipment (EVSE) and transmitting the captured communications to an external service. The disclosed examples include extracting a payload from messages communicated from EVSE and encoding the payload into Controller Area Network (CAN) messages. The CAN messages may be transmitted out to the external service for further logging and/or processing.

### CROSS-REFERENCE TO RELATED APPLICATIONS

This application claims priority to U.S. Provisional Patent Application No. 63/692,000 entitled “Electric Vehicle Communications,” which was filed on Sep. 6, 2024, the contents of which are incorporated herein by reference in their entirety.

### TECHNICAL FIELD

The present disclosure relates to capturing and transmitting charging-related communications between electric vehicle supply equipment (EVSE) and an electric vehicle to one or more additional (e.g., remote) systems.

### BACKGROUND

Electric vehicles are increasingly being developed and manufactured in an effort to reduce carbon emissions and other environmental impacts arising from the use of other (e.g., fossil fuel-powered) vehicles. Electric vehicles utilize one or more electric motors that may be powered from one or more batteries or other electrical energy storage devices. In order to provide opportunities for drivers to recharge these energy storage devices, electric vehicle charging stations including electric vehicle servicing/supply equipment (EVSE) have been installed around the world, providing power for use by charging systems of electric vehicles. In operation, the electric vehicle may be connected to a charge point (e.g., a power connector of the EVSE) and receive a charging current to recharge electrical energy storage devices (e.g., batteries) of the vehicle. The EVSE and electric vehicle may also exchange information in the form of ongoing data communications transmitted before, during, and/or after charging (e.g., including in circumstances where charging issues occur). In addition to coordinating charging operations between the EVSE and the electric vehicle these communications can provide contextual information useable to diagnose charging issues, track usage, and otherwise provide insight into the operation of the EVSE and electric vehicle. However, current approaches to access these communications require physical connection of an intermediate listening device measure and analyze the signaling between the EVSE and electric vehicle. These current methods of retrieval of the data cause difficultly in offboarding the data (e.g., to a remote server or other device), as a human operator has to be present to manually connect the listening device. Additionally, other approaches may access or offboard only a small subset of the communicated data, however, such approaches provide an incomplete picture of the charging session and result in less informed diagnostics and analyses relative to those based on the complete collection of communicated data.

### SUMMARY

The present disclosure includes description of technologies for providing an efficient system and method that addresses the above-mentioned limitations of conventional systems and methods and facilitates the communication of data exchanged between electric vehicles and EVSE to another computing system or device.

Aspects of the present disclosure relate to collecting and transmitting charging station communications from an electric vehicle to an off-board device. For example, the present disclosure includes description of technologies for providing a method for managing data communications between an electric vehicle and electric vehicle supply equipment (EVSE) during a charging session, including receiving, at the electric vehicle, the data communications from the EVSE, the data communications including a plurality of messages of a first type, and, for each message of the plurality of messages of the first type: encoding the data communications into one or more corresponding Controller Area Network (CAN) messages, and transmitting the one or more corresponding CAN messages to an external service without relying on a communication link between the EVSE and the external service.

The present disclosure further includes description of technologies for providing a system comprising a first interface of an electric vehicle, the first interface including a power input port connecting the electric vehicle to a charging port of electric vehicle supply equipment (EVSE) to receive charging current to charge a battery of the electric vehicle, a second interface of the electric vehicle, the second interface including a communication interface connecting the electric vehicle to an external service, and an electric vehicle communication controller comprising instructions executable by one or more processors of the electric vehicle to receive data messages from the EVSE via the first interface, encode respective payloads of the data messages into one or more corresponding Controller Area Network (CAN) messages, and transmit the one or more corresponding CAN messages to the external service via the second interface without relying on a communication link between the EVSE and the external service.

The present disclosure also includes description of technologies for providing a method for analyzing, with an external service, data communications exchanged between an electric vehicle and electric vehicle supply equipment (EVSE), the method comprising receiving, at the external service, one or more Controller Area Network (CAN) messages from the electric vehicle, the CAN messages including the data communications exchanged between the electric vehicle and the EVSE during a charging session, processing, with the external service, the CAN messages, storing, at a data storage device included in or accessible by the external service, data from the processed CAN messages, and performing a diagnostic or analysis on the electric vehicle or the EVSE based at least in part on the processed CAN messages.

Various objects, features, aspects, and advantages of the disclosed subject matter will become more apparent from the following detailed description of example features, along with the accompanying drawing figures in which like numerals represent like components.

### BRIEF DESCRIPTION OF THE DRAWINGS

FIG. 1 shows an example electric vehicle charging environment in accordance with one or more examples of the present disclosure.

FIG. 2 shows an example detailed block diagram of components of EVSE and an electric vehicle in accordance with one or more examples of the present disclosure.

FIG. 3 is a flow chart of an example method of receiving and propagating data communications between EVSE and an electric vehicle to an external service in accordance with one or more examples of the present disclosure.

FIG. 4 is a flow chart of an example method of receiving, at an external service, data communications between EVSE and an electric vehicle in accordance with one or more examples of the present disclosure.

FIG. 5 is a block diagram of an example computing environment in accordance with one or more examples of the present disclosure.

### DETAILED DESCRIPTION

The following is a detailed description of examples of the disclosure depicted in the accompanying drawings. The examples are in such detail as to clearly communicate the disclosure. However, the amount of detail offered is not intended to limit the anticipated variations of examples; on the contrary, the description herein is understood to cover all modifications, equivalents, and alternatives falling within the spirit and scope of the present disclosure, as well as those defined by the appended claims.

Electric vehicles (EVs) and electric vehicle supply equipment (EVSE) rely on data communication during charging sessions to coordinate operations, monitor performance, and diagnose issues. However, existing methods for accessing and analyzing these communications are limited and inefficient. Conventional approaches often require the use of intermediate listening devices, such as hardwired or near-field data sniffing mechanisms, to capture the data exchanged between the EVSE and the vehicle. These methods are cumbersome, requiring manual installation and operation, and are not typically integrated into the charging infrastructure. Furthermore, such approaches often fail to capture the full scope of the data exchanged, providing only a partial view of the communication stream. This incomplete data limits the ability to perform accurate diagnostics, identify trends, or predict potential issues. Additionally, the reliance on human intervention and external devices introduces delays, potential errors, and logistical challenges, particularly in large-scale or fleet-based EV operations.

In an aspect, the present system and method address one or more of these limitations by enabling seamless capture and transmission of the full scope of EVSE-to-vehicle communications to an external service without requiring intermediate devices or manual intervention. The described approach utilizes the electric vehicle's existing communication infrastructure to encode the data exchanged with the EVSE into Controller Area Network (CAN) messages. These CAN messages are then transmitted directly from the vehicle to an external service, such as a remote server, using the vehicle's communication interface. This method removes the dependency on a communication link between the EVSE and the external service, allowing the data to be transmitted independently of the EVSE's state or connectivity.

By integrating the data capture and transmission process into the vehicle's architecture, the described system provides a more efficient, reliable, and comprehensive solution. The use of CAN messages, a protocol already widely utilized within vehicles, enables seamless propagation of the data through the vehicle's internal systems to the communication interface. This minimizes hardware complexity and processing overhead while ensuring that the full payload of the EVSE-to-vehicle communications is preserved. The external service can then process the received CAN messages in real-time, enabling detailed diagnostics, trend analysis, and predictive maintenance. This approach not only simplifies the data collection process but also enhances the accuracy and timeliness of analyses, providing significant advantages over conventional methods.

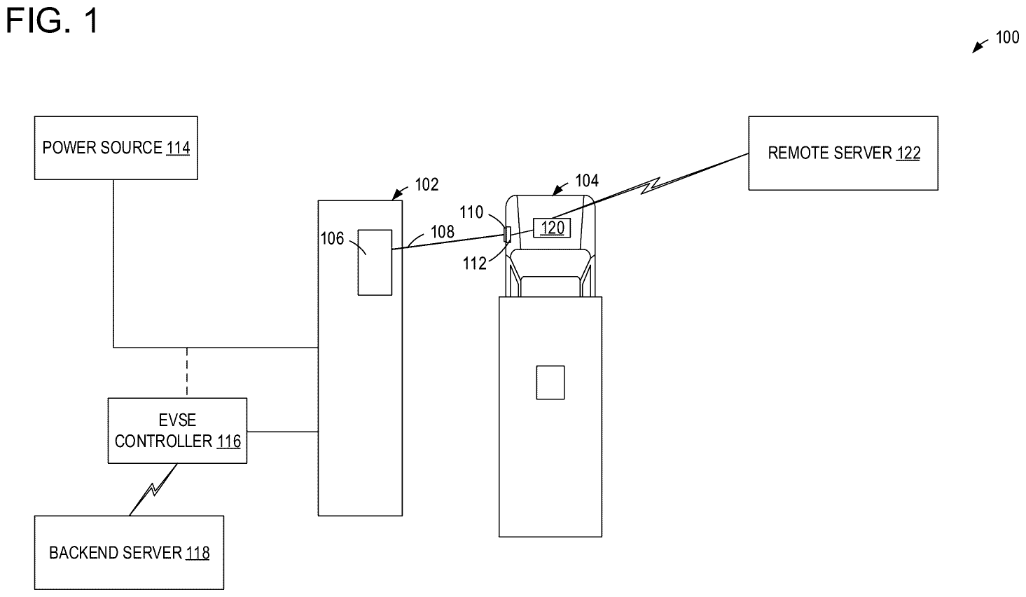

FIG. 1 shows an example charging station environment 100 including a charging station bay 102 and an electric vehicle 104. The electric vehicle 104 may include any suitable vehicle using one or more electric motors for propulsion, which includes an interface to receive charging current from electric vehicle supply equipment (EVSE). The electric vehicle 104 may include a fully electric and/or hybrid electric vehicle, and may include a commercial vehicle such as a semi-trailer truck or other commercial truck, van, etc. configured to haul, pull/tow, and/or perform other commercial duties. In other examples, the electric vehicle 104 may include a passenger vehicle such as a passenger car, truck, van, recreational vehicle, etc. The electric vehicle 104 may be any suitable vehicle type, including a road vehicle, off-road or recreational vehicle, marine vehicle, rail vehicle, aircraft, etc.

As shown, the charging station bay 102 includes a charging port 106 equipped with a cable 108 terminating in a connector 110 that is compatible with a power input port 112 of the electric vehicle 104. The charging station bay 102 (and associated charging port 106) receives power from a power source 114 (e.g., a power grid, power generation system, battery bank, etc.).

Although a single charging port and connector are shown in the illustrated example for clarity, it is to be understood that the charging station may include a plurality of charging station bays 102, and each bay may include one or more charging ports 106 having one or more cables 108/connectors 110 (e.g., where some ports may have multiple cables terminating in different types of connectors and/or different connector adapters for use with different power input ports of vehicles). In this way, the charging station includes electric vehicle supply equipment (EVSE) that may be capable of providing charging current to multiple vehicles simultaneously. Provisioning of the power from the power source, as well as other aspects of the operation of charging port 106 (and/or other charging ports of the EVSE), may be managed by an EVSE controller 116. For example, the EVSE controller 116 may include a computing system (e.g., an integrated circuit, an application-specific integrated circuit, or another computing/electronic device) that includes one or more processors and one or more data storage devices (e.g., memory) storing instructions executable by the one or more processors to perform one or more of the operations of the EVSE controller described herein. In additional or alternative examples, the EVSE controller 116 may include one or more electrical circuits and/or mechanical components configured to perform one or more of the operations of the EVSE controller described herein. The EVSE controller 116 may also include a communication interface that includes hardware, such as antenna(s) and/or data bus(ses)/port(s), and/or software/firmware, such as instructions stored in memory for a network controller or other communication circuit or chip, usable to communicate data using WIFI, BLUETOOTH, Ethernet, cellular communication channels, power-line communication, and/or other communication and/or transmission protocols. The operations of the EVSE controller 116 may include one or more of: monitoring components of the EVSE (e.g., for fault current detection, welding anomaly detection, protective earth conductor monitoring, charging plug emergency opener monitoring, etc.), logging information received from components of the EVSE and/or results of the above-described monitoring, performing dynamic load management of charge currents among charging ports of the EVSE (e.g., based on defined operational rules/policies and/or based on information received from the monitoring and/or the charging ports, for example to prevent an overload of the system/power supply from the power source 114 and/or to comply with power provisioning limits/rules/policies), and communicating with a backend server 118 for the EVSE (e.g., transmitting the logged information or other data, exchanging data to facilitate software/firmware updates or upgrades for the EVSE controller and/or other computing systems of the EVSE, etc.).

The cable 108 may be configured to deliver charging current to the vehicle 104 for recharging a battery of a charging system 120 of the vehicle, where the cable 108 is connectable to the vehicle 104 using the connector 110, which is adapted to mate with the power input port 112 of the vehicle. The cable 108 may also be configured to carry data communications (e.g., bidirectional communications) between the vehicle 104 and the charging port 106. For example, the cable 108 may be a conductor for power-line communications (PLC), where a modulated carrier signal is added to the wiring system for providing alternating and/or direct current (usable for recharging a connected vehicle) across the cable 108 and through the power input port 112. Accordingly, the power input port 112 may be an interface of the vehicle 104 that is able to receive the connector and facilitate the propagation of both power (e.g., current flow) and data between the charging port 106 and the electric vehicle 104. The modulated carrier signal may transmit information regarding an initial handshaking between the charging port 106 and the vehicle 104, operating status and/or configuration details of the charging port 106 and/or the vehicle 104, operating status of an ongoing charging operation (e.g., where the charging port 106 is supplying or attempting to supply charging current to the vehicle 104 over the cable 108), etc. In some examples, some or all of the data transmitted over the cable 108 is ingested and/or logged by the charging system 120 of the vehicle 104.

As noted above, the data communicated between the EVSE and the vehicle may provide contextual insight into operational issues and/or ongoing tracking data useable for detecting trends, predicting future issues, and/or performing other types of analysis. However, as vehicles typically have limited bandwidth for transmitting data wirelessly, other approaches to access any data that is communicated between the charging port 106 and the vehicle 104 may use hardwired or near-field data sniffing mechanisms (e.g., inductive couplers) installed between the charging port and the vehicle to detect or listen in on the communications. These approaches use additional equipment that is not typically available at charging stations, as well as an intermediate device to transmit from the sniffing device to a remote computing system. The disclosure provides approaches for processing the incoming data communications from the charging port and transmitting the data off-board from the vehicle (e.g., directly from the vehicle) to a remote device, such as remote server 122 of FIG. 1 without relying on a communication link between the EVSE and the external service. Transmitting the one or more corresponding CAN messages to an external service is performed independently of a state of the EVSE. For example, the remote server 122 may include a backend server or other computing system associated with the vehicle 104, such as a fleet management server, a vehicle manufacturer's or manager's server, etc., which is configured to receive the data from the vehicle (e.g., the data that is communicated between the charging port 106 and the vehicle 104) and store and/or further process the data (e.g., perform an analysis to detect, predict, and/or contextualize issues, identify trends, log operations, etc.). The remote server 122 may include one or more processors for executing instructions stored in memory to perform the data processing described above, and may include and/or access a historical database for performing the logging (and/or retrieving historical data to assist with the processing) operations described above.

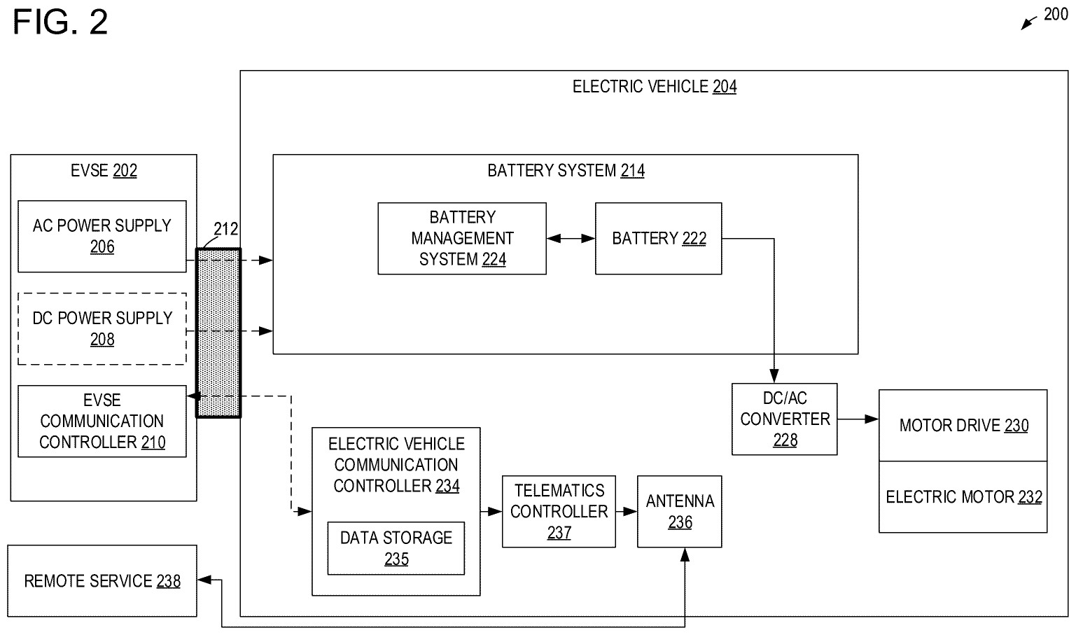

Referring to FIG. 2, exemplary components of an example system 200 including EVSE 202 and an electric vehicle 204 are shown. The EVSE 202 may be an example of EVSE in the charging station bay 102 and/or charging port 106 of FIG. 1 and the electric vehicle 204 may be an example of vehicle 104 of FIG. 1. It is to be understood that electric vehicle 204 may include additional and/or alternative components than those shown in FIG. 2. The EVSE 202 includes one or more power supplies, which may include an alternating current (AC) power supply 206 and/or a direct current (DC) power supply 208 configured to supply alternating current and direct current, respectively, to the electric vehicle for battery charging purposes. The EVSE 202 may also include an EVSE communication controller 210 for communicating data to the electric vehicle 204, as described in more detail below.

The current from the AC power supply 206 or the DC power supply 208 may be transmitted concurrently with data from the EVSE communication controller 210 over a cable 212 (e.g., for power-line communications, as described above with respect to FIG. 1) to a battery system 214 of the electric vehicle 204, the battery system including a battery management system 224 and a battery 222. In an example where the electric vehicle 204 is connected to receive AC power, alternating current from the AC power supply 206 may be provided to components of the battery system 214 to condition the current for use in charging the battery 222, such as a rectifier to convert the alternating current to direct current and/or a DC/DC converter to temporarily store the energy output by the rectifier in order to convert the direct current from a first voltage to a second voltage configured for the battery 222 (and/or to meet isolation targets for the vehicle). In some examples, the battery system 214 and/or the battery management system 224 may include one or more protection circuits configured to detect and/or prevent/reduce fault conditions such as overcurrent conditions. The output of the protection circuits and/or battery management system 224 is provided to the battery 222 to charge the battery for use by the vehicle. The battery management system 224 may also be configured to perform management operations such as monitoring a status of the battery (e.g., state of charge, temperature, performance characteristics, usage, estimated remaining life, etc.) and output instructions to the protection circuits and/or other components of the battery system 214 to control the flow of current to the battery. The battery 222 may output direct current to a DC to AC converter 228 configured to output alternating current to a motor drive 230 to drive an electric motor 232 of the vehicle 204 (e.g., where the electric motor powers one or more propulsion or other operating systems of the vehicle).

As described above, data may be exchanged between the EVSE 202 and the vehicle 204 using an electric vehicle communication controller (EVCC) 234. In some examples, the data communications may be sent over the cable 212 as power-line communications (e.g., communications compatible with IEEE 1901 standards). In additional or alternative examples, data may be communicated between the electric vehicle 204 (e.g., via the electric vehicle communication controller 234) and the EVSE 202 (e.g., via the EVSE communication controller 210) using any suitable communication protocol and/or mechanism/technology (e.g., via a wired communication link, such as an Ethernet connection, and/or a wireless communication link, such as WiFi, Bluetooth, Zigbee, Near-Field Communications, etc.). The electric vehicle communication controller 234 may include and/or access data storage 235, which may include one or more data storage devices configured to store data received from the EVSE 202. The data may be stored temporarily, for processing purposes, and/or more permanently/long-term, for logging purposes. In some examples, the data storage 235 is additionally configured to store (or buffer) data for transmission to the EVSE 202 and/or to store instructions for execution by a processor included in and/or associated with carrying out operations for the electric vehicle communication controller 234. The data received from the EVSE may be processed by the electric vehicle communication controller 234 and propagated (e.g., from the data storage 235) to a telematics controller 237, which prepares the data for transmission via antenna 236 to a remote service 238. The remote service 238 may be an example of remote server 122 of FIG. 1 and/or may include one or more computing systems or devices configured to receive data corresponding to the communications between the EVSE 202 and the electric vehicle 204. The antenna 236 may be configured to transmit wireless signals according to a suitable wireless protocol or mechanism/technology, such as WiFi, Bluetooth, cellular network communications (e.g., for cellular networks used by cellular phones or other mobile devices), Zigbee, Near-Field Communications, etc. In other examples, the electric vehicle may include a wired communication interface to propagate wired data signals to the remote service 238. The antenna 236 (or another signal propagation mechanism) may be configured for communication via one or more networks, which may include a wireless network, a wired network, or a combination thereof that can be implemented as one of the different types of networks, such as Intranet, Local Area Network (LAN), Wide Area Network (WAN), Internet, and the like. Further, the network can either be a dedicated network or a shared network. The shared network can represent an association of different types of networks that can use variety of protocols, for example, Hypertext Transfer Protocol (HTTP), Transmission Control Protocol/Internet Protocol (TCP/IP), Wireless Application Protocol (WAP), and the like.

In order to both capture all (or a majority) of the data communicated between the EVSE 202 and the electric vehicle 204 and transmit the data to the remote service 238 in a timely manner, the electric vehicle communication controller 234 may be configured to process the data by forming Controller Area Network (CAN) messages that include (e.g., in a payload of the CAN messages) the data communicated between the EVSE and the electric vehicle. For example, the electric vehicle communication controller 234 may include and/or manage communications throughout the vehicle 204 using one or more CAN buses. Accordingly, by translating the communications from the EVSE (which may be, for example, TCP/IP or other types of messages) into CAN messages, the data from these communications (e.g., the payload of the TCP/IP messages) can be efficiently propagated to the antenna 236 and transmitted out (e.g., over the air) to the remote service 238 with minimal delays and loss of data. The CAN messages may be received and processed by the remote service 238; for example, the remote service may read the received messages into corresponding packet capture (PCAP) files for further downstream processing (e.g., analysis, logging, etc., as described above with respect to remote server 122 of FIG. 1).

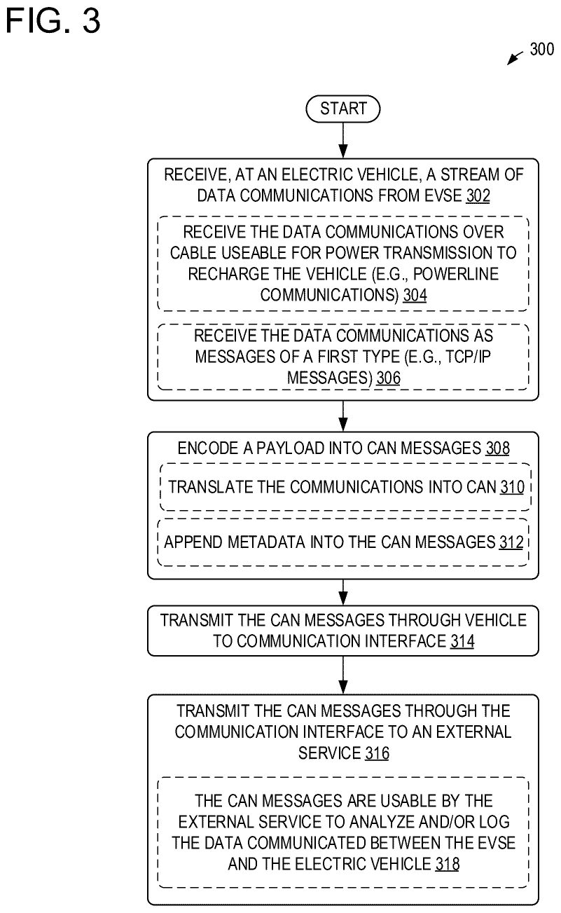

FIG. 3 is a flow chart of an example method 300 of managing data communications sent between EVSE and an electric vehicle in order to propagate the data to an external service. For example, method 300 may be performed by and/or in coordination with one or more components of the environment 100 of FIG. 1 and/or the system 200 of FIG. 2. At 302, the method includes receiving a stream of data communications from EVSE. For example, an electric vehicle, such as electric vehicle 104 of FIG. 1 and/or electric vehicle 204 of FIG. 2, may receive a plurality of data messages from the EVSE during a charging session (e.g., which may include a period of time within a window starting when the electric vehicle is connected to a charging port of the EVSE, as described with respect to FIG. 1 above, to a time when the electric vehicle is disconnected from the charging port; regardless of whether the electric vehicle receives power from the charging port during that window/period of time). The plurality of data messages may be received continuously and/or sequentially throughout the charging session as a stream of data messages. As indicated at 304, the data communications may be received over a cable (e.g., cable 108 of FIG. 1, cable 212 of FIG. 1, and/or another suitable cable) that is also useable for power transmission to recharge the vehicle (e.g., under a normal charging session when no charging issues are encountered). In some examples, the data communications received at 302 may be power-line communications. In other examples, the data communications received at 302 may be in accordance with a protocol, such as Ethernet, and transmitted over a power transmission cable. As indicated at 306, the data may be received as messages of a first type, such as TCP/IP messages or messages in accordance with another suitable protocol.

At 308, the method includes encoding a payload of the received data communications into CAN messages. For example, the messages may be received by an electric vehicle communication controller (EVCC), such as electric vehicle communication controller 234 of FIG. 2. The EVCC may store and/or process the messages in real-time to translate the communications received at 302 into CAN messages, as indicated at 310. In some examples, the EVCC may extract the payload, remove headers from the messages, and/or otherwise prepare the payload for repackaging into messages of a different type (e.g., the CAN messages). Optionally, the CAN messages formed at 308 may be appended with metadata, as indicated at 312. Metadata refers to additional information appended to CAN messages to provide context or supplementary details about the data being transmitted. Metadata may include, but is not limited to, an indication of the transmission protocol of the original data (e.g., TCP/IP) such as indicating the protocol of the original communications received at 302 and/or indicating that the original communications are of the first type, timestamps, error codes, or identifiers for the EVSE or electric vehicle.

At 314, the method includes transmitting the CAN messages through the vehicle to a communication interface. For example, the CAN messages may be propagated from the electric vehicle communication controller through one or more CAN buses to a telematics controller, such as telematics controller 237 of FIG. 2, and then propagated to an antenna, such as antenna 236 of FIG. 2. At 316, the method includes transmitting the CAN messages through the communication interface to an external service (e.g., remote server 122 of FIG. 1, remote service 238 of FIG. 2, and/or another computing system/service external to the electric vehicle) without relying on a communication link between the EVSE and the external service. In other words, in method 300, the electric vehicle always transmits the CAN messages via its own communication interface to the remote service 238, regardless of a state of a separate communication link between the EVSE and the remote service. For instance, in one example implementation, which should not be construed as limiting, the EVCC 234 sends the CAN messages via an internal CAN bus of the electric vehicle 204 to the telematics controller 237, which prepares the messages for wireless transmission, such as via a cellular protocol. The telematics controller 237 uses the cellular antenna 236 to send the CAN messages to the remote service 238, such as the remote fleet management server operated by the logistics company. Importantly, this transmission occurs independently of any communication link between the EVSE 202 and the remote service 238. For instance, even if the EVSE 202 lacks internet connectivity or its backend server 118 is temporarily offline, the EVCC 234 and telematics controller 237 of the electric vehicle 204 ensures that the data is sent directly to the remote service 238. This approach allows the remote service 238 to monitor the charging session in real-time, analyze the data for potential issues, and log the information for future diagnostics or trend analysis.

In some implementations, the method may include determining at the electric vehicle that the communication from the EVSE is associated with a problematic charging event, and transmitting the one or more corresponding CAN messages to the external service in response to determining that communication from the EVSE is associated with the problematic charging event. A problematic charging event relates to any condition or communication indicating an issue during a charging session that may affect the performance, safety, or efficiency of the charging process. Examples include, but are not limited to, overcurrent conditions, undervoltage conditions, failure to establish a stable charging connection, unexpected termination of charging, or error codes transmitted by the EVSE. In other words, some implementations of the method 300, rather than transmitting each and every CAN message to the remote service, only the CAN messages associated with problematic charging events are transmitted, thereby saving processing and transmission resources. In other implementations of method 300, each and every CAN message may be transmitted to the remote service. In still other implementations of the method 300, some other subset of the CAN messages may be transmitted to the remote service.

As described above with respect to FIGS. 1 and 2, the transmission to the external service may be performed over a wireless or wired connection, examples of which are described above. In this way, the data received at 302 may be transmitted substantially continuously and/or in real-time (e.g., subject to buffering/processing/transmission delays of the operations described in method 300) as the data is received. For example, the CAN messages may be sent at 316 in a sequential manner continuously in correspondence to the stream of messages that are received at 302. In this way, the electric vehicle may perform method 300 to continuously take snapshots of the received stream of data communications and send those snapshots to the external service in substantially real-time (e.g., during the charging session), so that the external service is able to receive the full stream of data communications (e.g., for a given message of the first type, the full payload is propagated to the external service rather than filtered/selected portions or data derived from the payload). As indicated at 318, the CAN messages may be useable by the external service to analyze and/or log the data communicated between the EVSE and the electric vehicle.

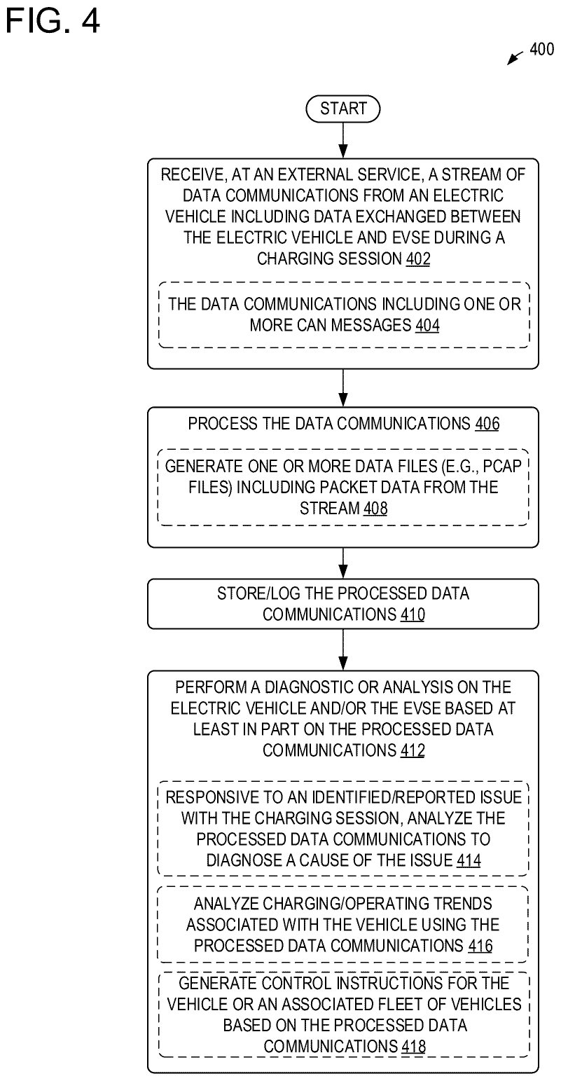

FIG. 4 is a flow chart of an example method 400 of receiving and processing data communications sent between EVSE and an electric vehicle at a remote service. For example, method 400 may be performed by and/or in coordination with one or more components of the environment 100 of FIG. 1 and/or the system 200 of FIG. 2, such as remote server 122 of FIG. 1 and/or remote service 238 of FIG. 2. At 402, the method includes receiving, at an external service, a stream of data communications from an electric vehicle including data exchanged between the electric vehicle and EVSE during a charging session. For example, as described above, an electric vehicle, such as electric vehicle 104 of FIG. 1 and/or electric vehicle 204 of FIG. 2, may receive a plurality of messages from the EVSE during a charging session (e.g., which may include a period of time within a window starting when the electric vehicle is connected to a charging port of the EVSE, as described with respect to FIG. 1 above, to a time when the electric vehicle is disconnected from the charging port; regardless of whether the electric vehicle receives power from the charging port during that window/period of time). The data received at 402 may correspond to data transmitted from an electric vehicle according to method 300 of FIG. 3 (e.g., the data transmitted at 316 of FIG. 3). For example, as indicated at 404, the data communications may include one or more CAN messages having the data communicated between the electric vehicle and the EVSE as at least a portion of payload.

At 406, the method includes processing the data communications. For example, as indicated at 408, the processing may include generating one or more data files (e.g., packet capture, PCAP, files) including packet data from the stream received at 402. At 410, the method includes storing and/or logging the processed data communications. For example, as described above, the external service may include and/or have access to one or more data storage devices and/or databases, which may be configured to store historical data relating to charging sessions of the electric vehicle and/or other associated electric vehicles (e.g., other vehicles managed/tracked by the external service, such as other vehicles in a fleet that includes the electric vehicle). Accordingly, the received and processed data communications (e.g., the PCAP files and/or data extracted from the CAN messages and/or PCAP files) may be stored in such storage/databases for subsequent tracking or analysis and/or for further processing.

At 412, the method includes performing a diagnostic or analysis on the electric vehicle and/or the EVSE based at least in part on the processed data communications. As one example, responsive to an identified and/or reported issue with the charging session associated with the data communications (or a future charging session), the external service may analyze the processed data and/or other logged processed data (e.g., from past charging sessions) to diagnose or estimate a cause of the issue, as indicated at 414. Similarly, the processed data communications may be used to predict a potential future issue. As indicated at 416, in another example, the external service may analyze charging and/or operating trends associated with the vehicle using the processed data communications. As an illustrative example, the length of the charging session may be determined based on the processed communication data and used to determine an average charging time associated with the vehicle in association with parameters of the EVSE. At 418, another example includes generating control instructions for the vehicle or an associated fleet of vehicles based on the processed data communications. As an illustrative example, responsive to detecting anomalies in the processed data communications, instructions to perform a firmware update to address the anomalies may be sent to the vehicle.

The disclosed technologies provide technical advantages relative to other approaches to access or analyze data communicated between EVSE and an electric vehicle. For example, as described above, the disclosed technologies enable all of the above-described communicated data to be transmitted wirelessly from the electric vehicle to a remote service for analysis, without use of a manually-installed intermediate device, such as a listening device or data sniffing device. Additionally, the encoding of incoming data communications/messages into CAN messages in disclosed examples of the technology described herein takes advantage of the communication protocol already known and in-use by the vehicle to allow the content from the data messages to be propagated from the interface with the EVSE to the telematics system in order to be (e.g., wirelessly) transmitted to a remote server. This reduces the complexity and hardware resources for sending the data, and also increases an ease-of-use of the system by enabling the data to be sent via seamless, automatic operating processes of the vehicle without the delays and potential errors introduced by human intervention to install a secondary device for each charging session. Furthermore, by capturing and sending all of the communicated data in real-time during a charging session, a more detailed, timely, and accurate analysis and/or diagnostic may be performed relative to approaches that send only a subset of the communicated data and/or that store data for later transmission. For example, by using the disclosed technologies, control of a vehicle, EVSE, and/or fleet of vehicles may be better optimized relative to other approaches, since the diagnostics, analysis, and/or control instruction generation performed at 412 of FIG. 4 is based on more complete and timely information as described above.

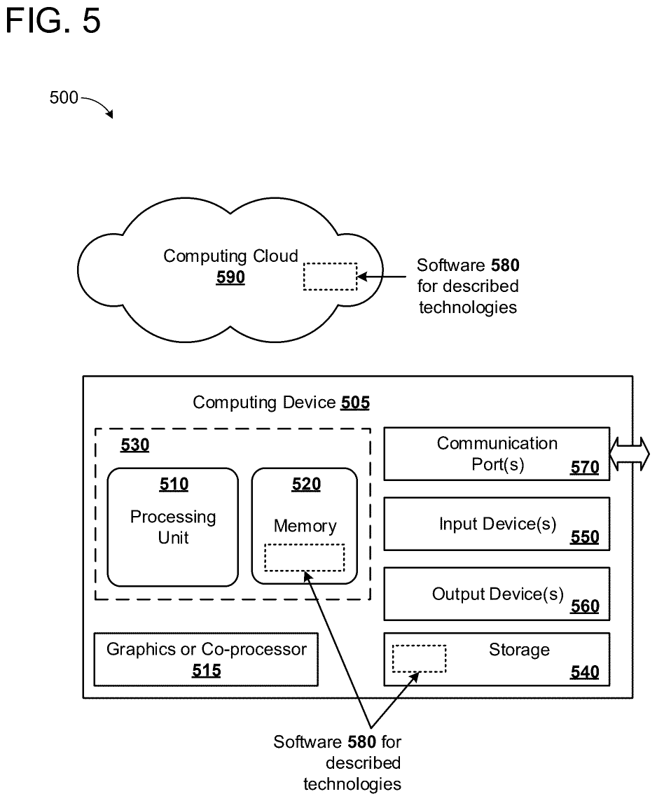

FIG. 5 depicts a generalized example of a suitable computing environment 500 in which the described innovations may be implemented. For example, the computing environment 500 and/or one or more components of the computing environment 500 may include and/or be included in one or more of the components of environment 100 of FIG. 1 and/or system 200 of FIG. 2 and/or may be used to perform the method 300 of FIG. 3 and/or method 400 of FIG. 4. The computing environment 500 is not intended to suggest any limitation as to scope of use or functionality, as the innovations may be implemented in diverse general-purpose or special-purpose computing systems. For example, the computing environment 500 can be any of a variety of computing devices (e.g., desktop computer, laptop computer, server computer, tablet computer, etc.).

With reference to FIG. 5, the computing environment 500 includes a computing device 505, which may be implemented locally and/or remotely, such as in a cloud computing environment 590. The computing device 505 has one or more processing units 510, 515 and one or more memories 520. In FIG. 5, a basic configuration 530 of processing unit 510 and memory 520 is included within a dashed line. The processing units 510, 515 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 5 includes a central processing unit 510 as well as a graphics processing unit or co-processing unit 515. The tangible memory 520 may be volatile memory (e.g., registers, cache, RAM), non-volatile memory (e.g., ROM, EEPROM, flash memory, etc.), or some combination of the two, accessible by the processing unit(s). The memory 520 stores software 580 implementing one or more innovations described herein, in the form of computer-executable instructions suitable for execution by the processing unit(s).

A computing system may have additional features. For example, the computing environment 500 includes storage 540, one or more input devices 550, one or more output devices 560, and one or more communication connections 570. An interconnection mechanism (not shown) such as a bus, controller, or network interconnects the components of the computing environment 500. Typically, operating system software (not shown) provides an operating environment for other software executing in the computing environment 500, and coordinates activities of the components of the computing environment 500.

The tangible storage 540 may be removable or non-removable, and includes magnetic disks, magnetic tapes or cassettes, CD-ROMs, DVDs, or any other medium which can be used to store information in a non-transitory way and which can be accessed within the computing environment 500. The storage 540 stores instructions for the software 580 implementing one or more innovations described herein.

The input device(s) 550 may be a touch input device such as a keyboard, mouse, pen, or trackball, a voice input device, a scanning device, or another device that provides input to the computing environment 500. The output device(s) 560 may be a display, printer, speaker, CD-writer, or another device that provides output from the computing environment 500.

The communication connection(s) 570 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed examples can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, aspects of the disclosed technology can be implemented by software written in C++, Java, Perl, any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

In a first example, a method for managing data communications between an electric vehicle and electric vehicle supply equipment (EVSE) during a charging session, the method comprises receiving, at the electric vehicle, the data communications from the EVSE, the data communications including a plurality of messages of a first type; and for each message of the plurality of messages of the first type: encoding the data communications into one or more corresponding Controller Area Network (CAN) messages, and transmitting the one or more corresponding CAN messages to an external service without relying on a communication link between the EVSE and the external service.

A second example includes the first example and further includes the method, wherein the one or more corresponding CAN messages are transmitted to the external service during the charging session.

A third example includes the first and/or second example and further includes the method, wherein the one or more corresponding CAN messages are usable by the external service to analyze or log the data communications from the EVSE.

A fourth example includes one or more of the first through third examples, and further includes the method, wherein the plurality of messages of the first type include Transmission Control Protocol/Internet Protocol (TCP/IP) messages.

A fifth example includes one or more of the first through fourth examples, and further includes the method, wherein encoding the data communications into the one or more corresponding CAN messages further comprises appending metadata into the one or more corresponding CAN messages.

A sixth example includes one or more of the first through fifth examples, and further includes the method, wherein the metadata includes an indication of a transmission protocol of the data communications from the EVSE.

A seventh example includes one or more of the first through sixth examples, and further includes the method, wherein the one or more corresponding CAN messages are transmitted over a CAN bus of the electric vehicle to a communication interface of the electric vehicle.

An eighth example includes one or more of the first through seventh examples, and further includes the method, wherein transmitting the one or more corresponding CAN messages to the external service comprises transmitting the one or more corresponding CAN messages to the external service over a wireless communication link.

A ninth example includes one or more of the first through eighth examples, and further includes the method, wherein the data communications from the EVSE are received via power-line communication.

A tenth example includes one or more of the first through ninth examples, and further includes the method, wherein the data communications from the EVSE are received via an Ethernet connection.

In an eleventh example, a system comprises: a first interface of an electric vehicle, the first interface including a power input port connecting the electric vehicle to a charging port of electric vehicle supply equipment (EVSE) to receive charging current to charge a battery of the electric vehicle; a second interface of the electric vehicle, the second interface including a communication interface connecting the electric vehicle to an external service; and an electric vehicle communication controller comprising instructions executable by one or more processors of the electric vehicle to receive data messages from the EVSE via the first interface, encode respective payloads of the data messages into one or more corresponding Controller Area Network (CAN) messages, and transmit the one or more corresponding CAN messages to the external service via the second interface without relying on a communication link between the EVSE and the external service.

A twelfth example includes the eleventh example, and further includes the system, wherein the communication interface comprises an antenna configured to send the one or more corresponding CAN messages to the external service using wireless communication.

A thirteenth example includes the eleventh and/or twelfth examples, and further includes the system, wherein the one or more corresponding CAN messages are usable by the external service to analyze or log the data messages from the EVSE.

A fourteenth example includes one or more of the eleventh through thirteenth examples, and further includes the system, wherein the power input port is connected to the electric vehicle communication controller to provide the data messages to the electric vehicle communication controller.

A fifteenth example includes one or more of the eleventh through fourteenth examples, and further includes the system, wherein the data messages include Transmission Control Protocol/Internet Protocol (TCP/IP) messages.

A sixteenth example includes one or more of the eleventh through fifteenth examples, and further includes the system, wherein the data messages are received from the EVSE via the power input port using power-line communication or Ethernet communication.

In a seventeenth example, a method for analyzing, with an external service, data communications exchanged between an electric vehicle and electric vehicle supply equipment (EVSE), the method comprises: receiving, at the external service, one or more Controller Area Network (CAN) messages from the electric vehicle, the CAN messages including the data communications exchanged between the electric vehicle and the EVSE during a charging session; processing, with the external service, the CAN messages; storing, at a data storage device included in or accessible by the external service, data from the processed CAN messages; and performing a diagnostic or analysis on the electric vehicle or the EVSE based at least in part on the processed CAN messages.

An eighteenth example includes the seventeenth example, and further includes the method, wherein processing the CAN messages includes generating one or more packet capture data files including packet data from the CAN messages.

A nineteenth example includes the seventeenth and/or eighteenth examples, and further includes the method, wherein performing the diagnostic or analysis includes diagnosing or predicting an issue with the charging session based at least in part on the processed CAN messages.

A twentieth example includes one or more of the seventeenth through nineteenth examples, and further includes the method, further comprising generating control instructions for the electric vehicle or an associated fleet of electric vehicles based at least in part on the processed CAN messages or the diagnosed or predicted issue.

A twenty-first example includes the method of example 1, wherein transmitting the one or more corresponding CAN messages to the external service is performed independently of a state of the EVSE.

A twenty-second example includes the method of example 1, further including determining at the electric vehicle that a communication from the EVSE is associated with a problematic charging event; and transmitting the one or more corresponding CAN messages to the external service in response to determining that the communication from the EVSE is associated with the problematic charging event.

The disclosed methods, apparatus, and systems should not be construed as limiting in any way. Instead, the present disclosure is directed toward all novel and nonobvious features and aspects of the various disclosed examples, alone and in various combinations and subcombinations with one another. The disclosed methods, apparatus, and systems are not limited to any specific aspect or feature or combination thereof, nor do the disclosed examples require that any one or more specific advantages be present or problems be solved.

In view of the many possible examples to which the principles of the disclosed invention may be applied, it should be recognized that the illustrated examples are only examples of the invention and should not be taken as limiting the scope of the invention. We therefore claim as our invention all that comes within the scope of these claims.

What is claimed is:

1. A method for managing data communications between an electric vehicle and electric vehicle supply equipment (EVSE) during a charging session, the method comprising:
receiving, at the electric vehicle, the data communications from the EVSE, the data communications including a plurality of messages of a first type; and
for each message of the plurality of messages of the first type:
encoding the data communications into one or more corresponding messages of a second type, and
transmitting the one or more corresponding messages of the second type to an external service without relying on a communication link between the EVSE and the external service.

2. The method of claim 1, wherein the one or more corresponding messages of the second type are transmitted to the external service during the charging session.

3. The method of claim 1, wherein the one or more corresponding messages of the second type are usable by the external service to analyze or log the data communications from the EVSE.

4. The method of claim 1, wherein the plurality of messages of the first type include Transmission Control Protocol/Internet Protocol (TCP/IP) messages.

5. The method of claim 1, wherein the one or more corresponding messages of the second type comprise Controller Area Network (CAN) messages.

6. The method of claim 1, wherein encoding the data communications into the one or more corresponding messages of the second type further comprises appending metadata into the one or more corresponding messages of the second type.

7. The method of claim 6, wherein the metadata includes an indication of a transmission protocol of the data communications from the EVSE.

8. The method of claim 1, wherein the one or more corresponding messages of the second type are transmitted over a bus of the electric vehicle to a communication interface of the electric vehicle.

9. The method of claim 1, wherein transmitting the one or more corresponding messages of the second type to the external service comprises transmitting the one or more corresponding messages of the second type to the external service over a wireless communication link.

10. The method of claim 1, wherein the data communications from the EVSE are received via power-line communication.

11. The method of claim 1, wherein the data communications from the EVSE are received via an Ethernet connection.

12. The method of claim 1, wherein transmitting the one or more corresponding messages of the second type to the external service is performed independently of a state of the EVSE.

13. The method of claim 1, comprising:
determining at the electric vehicle that a communication from the EVSE is associated with a problematic charging event; and
transmitting the one or more corresponding messages of the second type to the external service in response to determining that the communication from the EVSE is associated with the problematic charging event.

14. A system comprising:
a first interface of an electric vehicle, the first interface including a power input port connecting the electric vehicle to a charging port of electric vehicle supply equipment (EVSE) to receive charging current to charge a battery of the electric vehicle;
a second interface of the electric vehicle, the second interface including a communication interface connecting the electric vehicle to an external service; and
an electric vehicle communication controller comprising instructions executable by one or more processors of the electric vehicle to receive data messages of a first type from the EVSE via the first interface, encode respective payloads of the data messages into one or more corresponding messages of a second type, and transmit the one or more corresponding messages of the second type to the external service via the second interface without relying on a communication link between the EVSE and the external service.

15. The system of claim 14, wherein the one or more corresponding messages of the second type comprise Controller Area Network (CAN) messages.

16. The system of claim 15, wherein the communication interface comprises an antenna configured to send the one or more corresponding messages of the second type to the external service using wireless communication.

17. The system of claim 15, wherein the one or more corresponding messages of the second type are usable by the external service to analyze or log the data messages from the EVSE.

18. The system of claim 15, wherein the power input port is connected to the electric vehicle communication controller to provide the data messages to the electric vehicle communication controller.

19. The system of claim 15, wherein the data messages include Transmission Control Protocol/Internet Protocol (TCP/IP) messages.

20. The system of claim 15, wherein the data messages are received from the EVSE via the power input port using power-line communication or Ethernet communication.

21. A method for analyzing, with an external service, data communications exchanged between an electric vehicle and electric vehicle supply equipment (EVSE), the method comprising:
receiving, at the external service, one or more messages from the electric vehicle without relying on a communication link between the EVSE and the external service, the messages including the data communications exchanged between the electric vehicle and the EVSE during a charging session;
processing, with the external service, the messages;
storing, at a data storage device included in or accessible by the external service, data from the processed messages; and
performing a diagnostic or analysis on the electric vehicle or the EVSE based at least in part on the processed messages.

22. The method of claim 21, wherein processing the messages includes generating one or more packet capture data files including packet data from the messages.

23. The method of claim 21, wherein performing the diagnostic or analysis includes diagnosing or predicting an issue with the charging session based at least in part on the processed messages.

24. The method of claim 23, further comprising generating control instructions for the electric vehicle or an associated fleet of electric vehicles based at least in part on the processed messages or the diagnosed or predicted issue.

25. The method of claim 21, wherein the messages comprise Controller Area Network (CAN) messages.
